(19) United States
(12) Patent Application Publication
(10) Pub. No.: US 2008/0074607 A1
(43) Pub. Date: Mar. 27, 2008

(54) Scuba diving mask with corrective lenses

(75) Inventor: Carlos Alberto Godoy, Genova (IT)

Correspondence Address: POLLACK, P.C., THE CHRYSLER BUILDING, 132 EAST 43RD STREET, SUITE 760, NEW YORK, NY, 10017, US

(73) Assignee: Cressi-Sub S.p.A.

(21) Appl. No.: 11/901,425

(22) Filed: Sep. 16, 2007

(30) Foreign Application Priority Data
Sep. 15, 2006 (IT) FI2006U000058

(51) Int. Cl. G02C 1/00

(52) U.S. Cl. 351/43

(57) ABSTRACT

A scuba diving mask with corrective lenses comprising a frame with a pair of rings connected by a bridge, each of the rings having an internal flange on which the lip of a flexible skirt, a corresponding lens and a lens-retaining collar rest. The collar is attached with a snap action to the corresponding ring. A seat is formed in the bridge substantially in the lying plane of the lenses and extending laterally to the upper internal portion of the two rings. The seat contains a locking plate slidable between two opposite end stroke positions, a locking end position and a release end position respectively, when the locking plate is in the locking position the lateral sides of the locking plate extend inside the rings and are engaged in corresponding notches provided in the upper internal rim of the lens-retaining collars.

### FIELD OF THE INVENTION

The present invention relates generally to swimming and underwater activities and, more particularly, to optical equipment for scuba diving or the like.

### BACKGROUND OF THE INVENTION

Conventional scuba diving masks, for example, can often be retrofitted with corrective lenses in order to meet the demands of scuba divers who often need to compensate for their poor eyesight during underwater activities.

The masks of the known type suitable for fitting corrective lenses generally have several specific features as summarized below.

The frame of the mask comprises two, not necessarily circular, rigid rings connected together by means of a bridge designed to be positioned over the user nose. The internal contour of each ring is provided with flanges against which the so-called “visors”, i.e. the transparent lenses allowing the user to see underwater, are rested. Said visors are held in position by means of retaining collars that replicate the internal contour of the above-mentioned rings and are permanently or removably attached to the frame by suitable fixing means.

In scuba diving masks provided with corrective lenses, the same lens can generally be mounted both on the right-hand side and on the left-hand side of the mask, simply by rotating the lens around an axis perpendicular to the plane of the lens, i.e. the lenses are symmetrical in order to avoid obliging retailers to keep double sets of right- and left-hand lenses.

The manufacturer consequently provides retailers with scuba diving masks without any lenses together with a set of corrective lenses that the retailer can subsequently fit in the masks to suit the customer requirements. Of course, this type of dedicated mask for use with corrective lenses can also be fitted with ordinary lenses.

The assembly or replacement of the lenses by the retailer needs the use of suitable equipment, which generally consists of a dedicated tool—a simple screwdriver, in many cases—by means of which the two retaining collars can be separated from the mask frame in order to insert or change the lens. As a rule, the retailer has been suitably instructed for said purpose and is capable of performing the above-mentioned operations without damaging the lenses or the frame of the mask by scratching, for instance. However it is clear that the risk of mask damage is always involved in said operation because the dedicated tool is generally harder than the lens or the frame of the mask.

For this reason, when lenses are fitted or replaced by the end user, without the dedicated tool and/or without the necessary experience, there is a greater risk of damaging the lenses or the frame of the mask. It is also worth emphasizing that the action of replacing a lens, and even more of installing a lens, carries the additional risk of damaging the lip of the skirt arranged between the frame and the lens, with the potential consequence of the loss of the mask watertightness.

This also applies to the case in which the mask is provided with ordinary lenses and the user needs to replace a damaged visor.

### OBJECTS AND SUMMARY OF THE INVENTION

Accordingly, it is an object of the present invention to provide a scuba diving mask for selectively mounting corrective lenses which does not require the use of special tools for assembly and replacement of the lenses and where such assembly and replacement is easy for any user to perform, thereby eliminating any risk of damage to the mask frame, the lenses or the skirt and consequential loss of watertightness of the mask.

This object is achieved with a scuba diving mask provided with corrective lenses according to the present invention, in which the bridge has a seat arranged substantially in the lying plane of the lenses and extending laterally to the upper internal portion of the two rings. A locking plate is slidingly housed inside the seat so that it can slide between two opposite end stroke positions, a locking end position and a release end position respectively. When the locking plate is in the locking position, the lateral sides of the locking plate extend inside the rings and are engaged in corresponding notches provided in the upper internal rim of the lens-retaining collars. The collars are thus locked against the rings, thereby stabilizing the structure of the mask, which can only be disassembled by sliding the plate relative to the bridge with the aid of a suitable tool.

### BRIEF DESCRIPTION OF THE DRAWINGS

A specific, illustrative scuba diving mask with corrective lenses, according to the present invention, is described below with reference to the accompanying drawings, in which:

FIG. 1 is a front view of a scuba diving mask, according to one aspect of the present invention, including corrective lenses, corresponding lens-retaining collars, and a device for locking the collars in place;

FIGS. 1-1d are sectional views of the mask shown in FIG. 1 taken along lines 1a-1a, 1b-1b, 1c-1c and 1d-1d, respectively;

FIG. 2 is a perspective view of the mask frame shown in FIG. 1 without the skirt, the lenses and the lens-retaining collars;

FIGS. 2a-2c are sectional views of the mask illustrated in FIGS. 1a-1d showing only the mask frame;

FIG. 3 is a front view of the lens-retaining collars set forth in FIG. 1, in position upon installation on the frame of the mask;

FIGS. 3a-3c are sectional views of the lens-retaining collars illustrated in FIGS. 1a-1d, showing only the lens-retaining collar;

FIG. 4 is a rear perspective view of the lens-retaining collars shown in FIG. 3;

FIG. 5 is a sectional view taken along lines V-V of FIG. 1;

FIG. 6 is a front perspective view of a sliding element in the bridge of the mask shown in FIG. 1; and

FIG. 7 is a rear perspective view of the sliding element illustrated in FIG. 6.

Still other objects and advantages of the present invention will become apparent from the following description of the preferred embodiments.

### DETAILED DESCRIPTION OF THE PREFERRED EMBODIMENTS

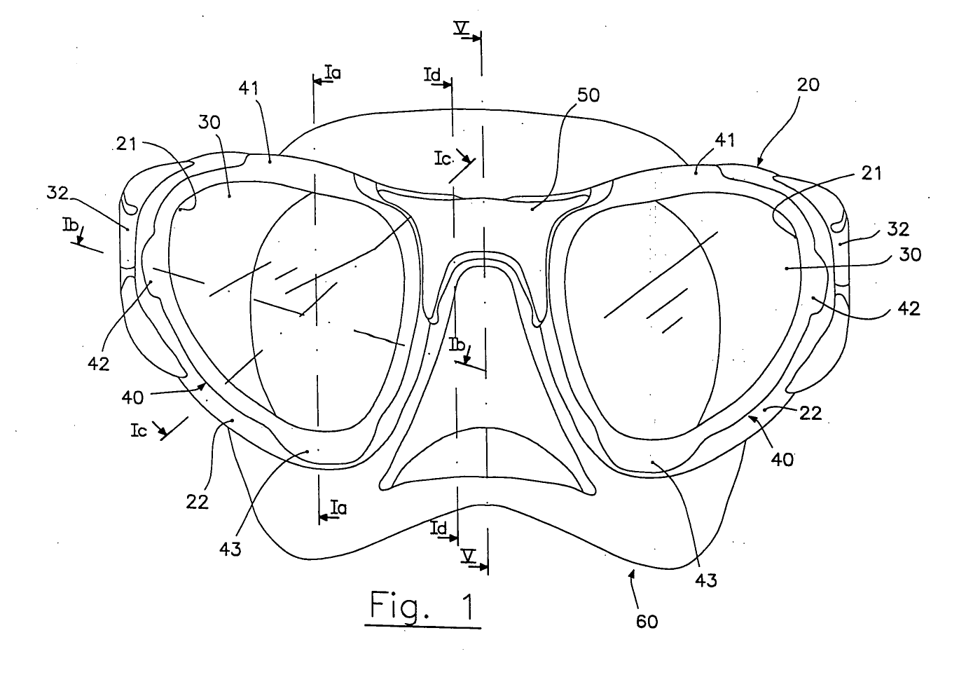

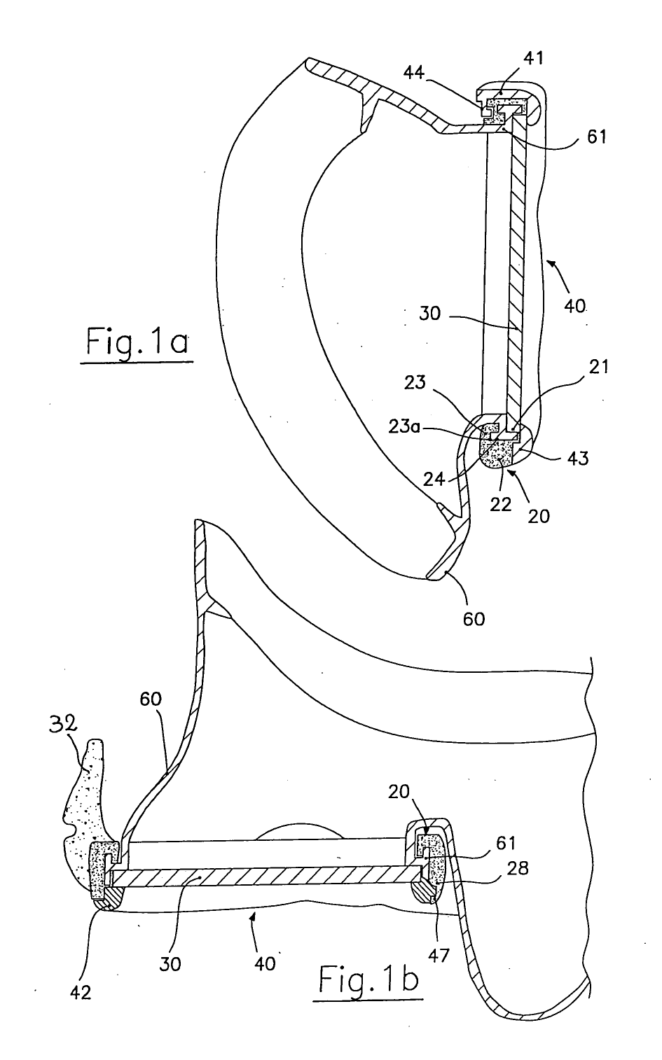

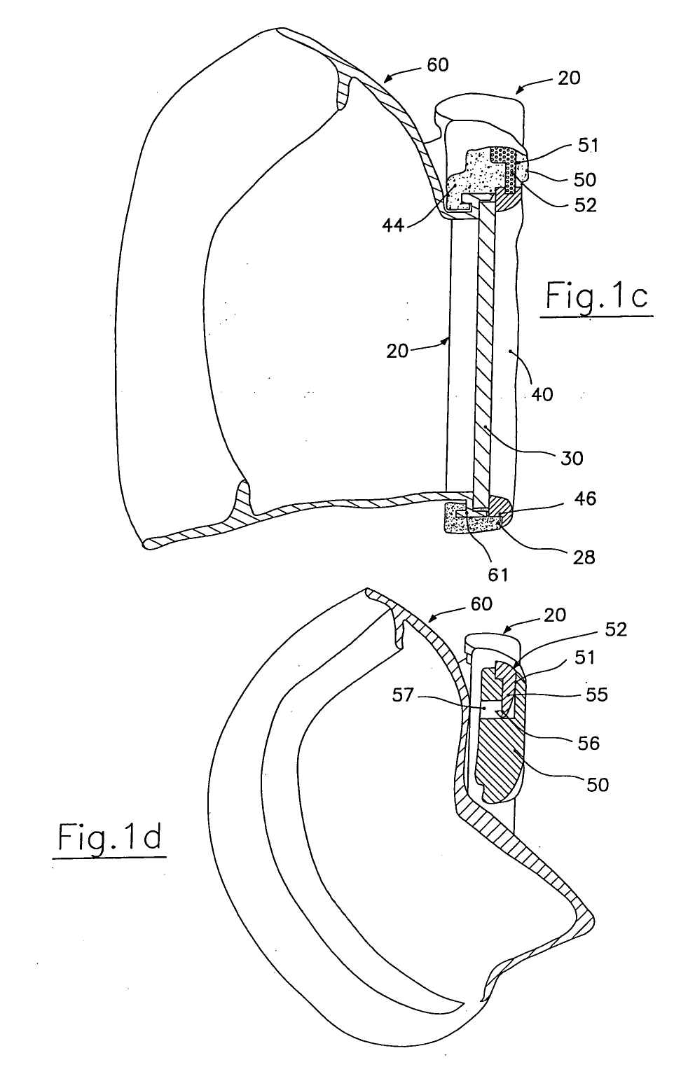

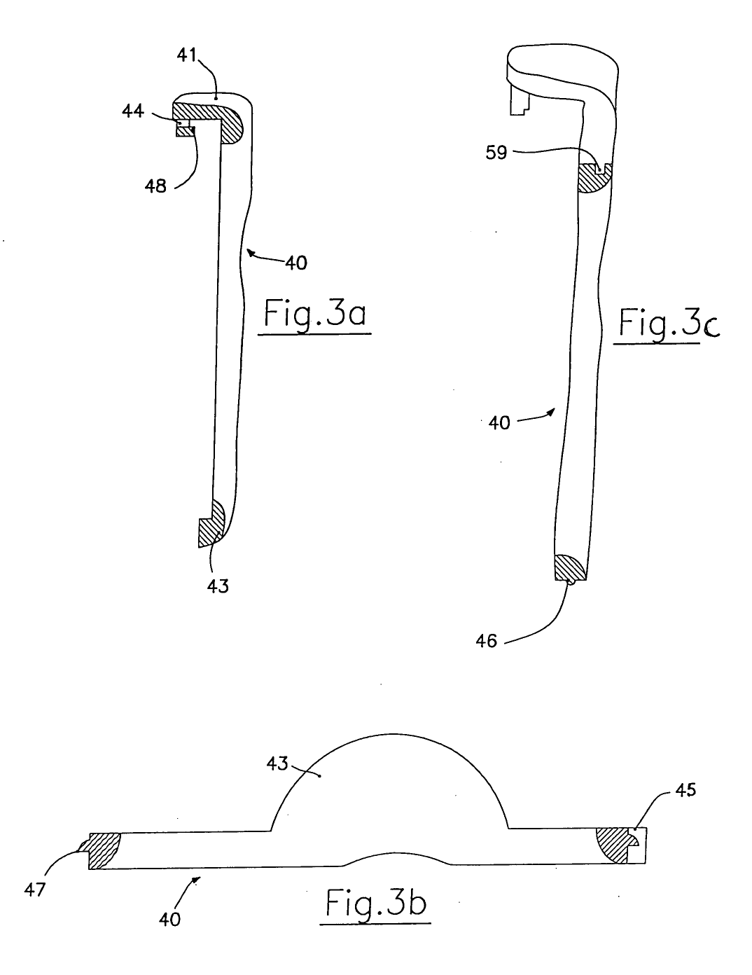

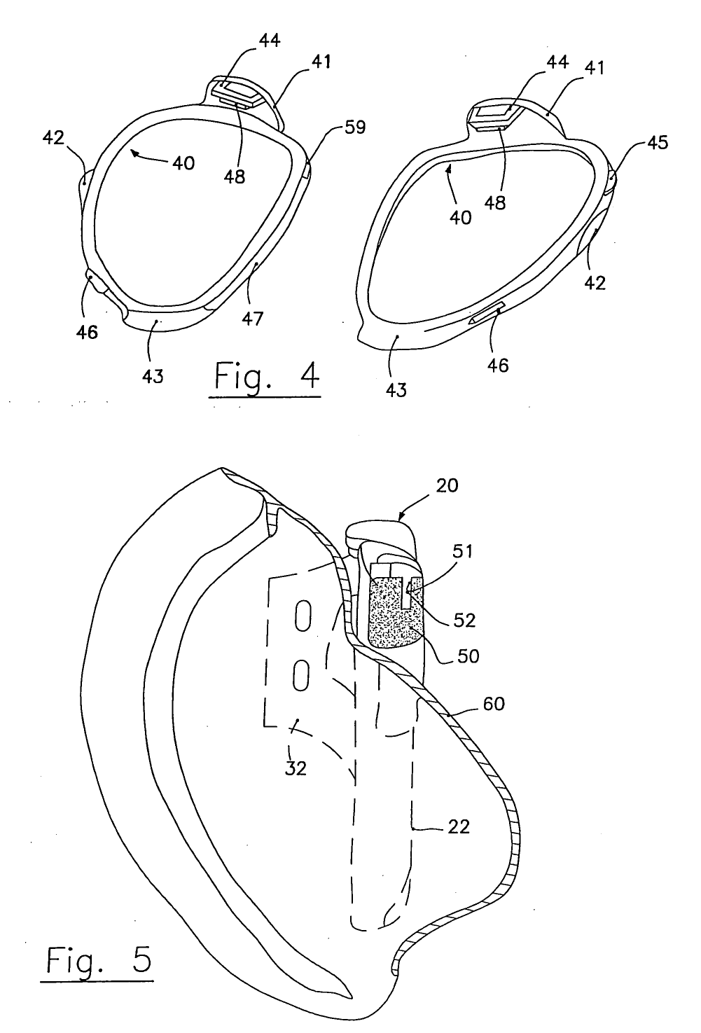

Referring now to the drawings and, more particularly, to FIGS. 1-7, there is shown generally a specific, illustrative mask with corrective lenses, according to various aspects of the present invention. In one embodiment, illustrated generally in FIG. 1, the mask comprises a frame 20 having a pair of symmetrical rings 22 surrounding two symmetrical openings 21. The rings have a substantially L-shaped cross-section which comprises an internal flange 23 and an internal cylindrical surface 24 for positioning a lens 30 that, after insertion of a lip 61 of a skirt 60, is locked against the internal flange by a collar 40, shown in detail in FIGS. 3-4. Preferably, two brackets 32 extend laterally from rings 22. A strap is adjustably attached to the brackets in a conventional manner such as using buckles (not shown).

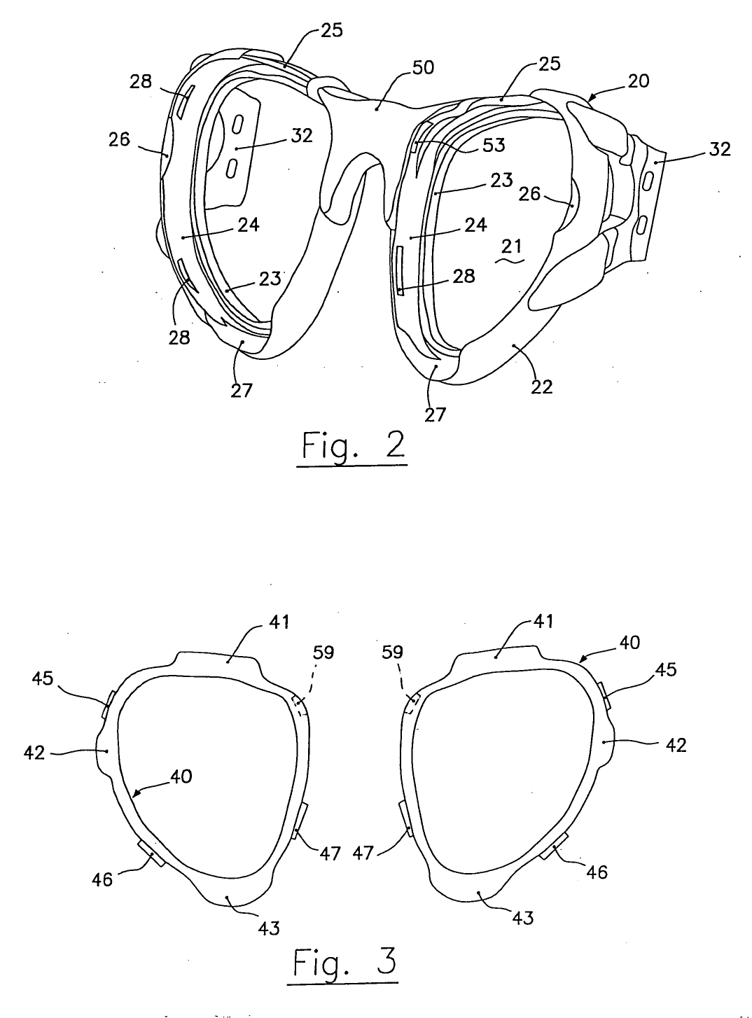

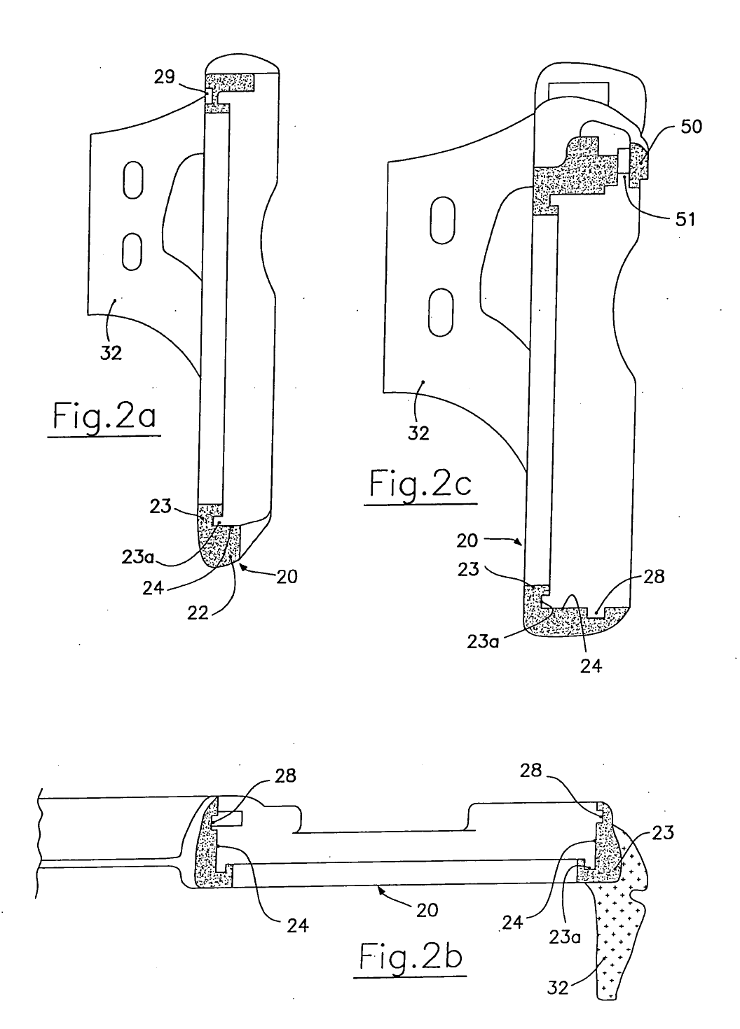

For the proper positioning of each collar 40 around an axis substantially perpendicular to the plane on which it lies, inside the opening 21 of the corresponding ring 22, the collar 40 has three flanges—41 (upper), 42 (lateral) and 43 (lower)—that surround the outside of at least a portion of the ring 22. In a preferred embodiment, the flanges 41, 42 and 43 engage in corresponding housing 25, 26 and 27 in the outer contour of the ring 22, as shown in FIG. 2.

For the proper axial positioning of the collar 40, the upper flange 41 also has a tooth 44 hooking the back of the ring 22. A rib 48 extends from the tooth 44 and engages in a groove 29 provided on the back of the ring 22 (see FIGS. 1a, 2a and 3a).

Moreover, each collar 40 has further teeth 45, 46 and 47 (see FIGS. 3 and 4) on its outer lateral surface that engage in corresponding recesses 28 (FIG. 2) in the cylindrical internal surface 24 of the rings 22 (see, for instance, in FIG. 1c).

The flexibility of the flanges 41, 42 and 43—associated with the intrinsic flexibility of the collars 40 and of the rings 22 of the frame 20—allow the collars 40 to be attached with a snap action to the respective rings 22, after the lip 61 of the skirt 60 and of the corrective lens 30 have been inserted in the openings 21. The flexibility of these elements could, however, allow the unwanted detachment of a collar 40 from the corresponding ring 22 on the frame 20 due, for instance, to an impact.

According to one aspect of the invention, to overcome this drawback (as shown in FIGS. 1c, 2c, 3c, 5, 6 and 7) the bridge 50 that joins the two symmetrical rings 22 has a seat in the form of a slot 51, as shown in the example, lying substantially parallel to the lying plane of the lenses, in which a locking plate 52 is slidingly engaged and movable between two opposite end stroke positions, an upper end position in which it extends partially from the bridge 50, and a lower end position in which the locking plate extends laterally into the surface 24 of the rings 22 through slits 53 visible in FIG. 2.

Likewise, the collar 40 has a corresponding notch 59 (FIGS. 3, 3c, 5) suitable for containing a lateral side 58 of the locking plate 52 when it is in its lowered end position, thereby locking the collar 40 inside the ring 22. The upper and lower end positions of stroke define, respectively, a release end position and a locking end position for the locking plate with relation to the collars-rings fitting.

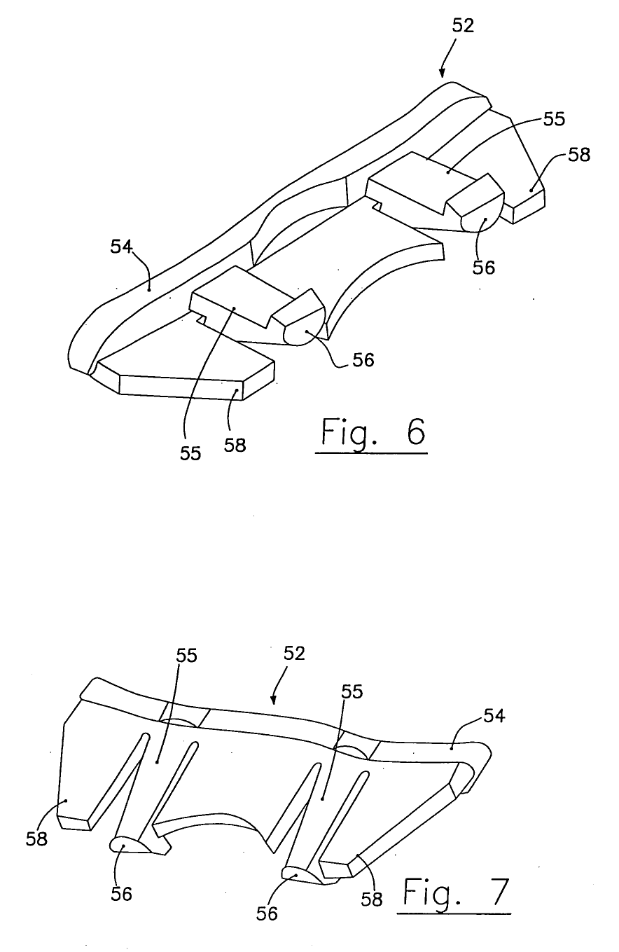

The locking plate 52 is shown in FIGS. 6 and 7. To unequivocally define its lowermost working position, the locking plate 52 is provided with an upper flange 54 that rest against the upper border of the bridge 50 to prevent its further downward movement.

Similarly, to unequivocally define its uppermost position and prevent its complete extraction, on the opposite side of the flange 54 the locking plate 52 has a projection 56 slidingly engaged in an elongated opening 57 formed in the bridge. More particularly, as shown in FIGS. 1d, 6 and 7, the projection consists of a pair of feet 56 extending from respective legs 55 of the locking plate 52. Feet 56 are engaged in the opening 57, whose length defines the stroke of the locking plate 52 inside the slot 51.

To assemble the mask, first the lip 61 of the skirt 60 is inserted in the rings 22 so as to abut against their internal flange 23. Then the lens 30 is rested on the lip 61 of the skirt. Finally, the collar 40 is mounted on the lens 30. The collar is slightly pressed laterally and inserted in the openings 21 so that the teeth 45, 46 and 47 fit into the cavities 28. Then the upper part of the collar 40 is pressed so that the tooth 44 on the upper flange 41 snaps into the rear surface of the ring 22 and the rib 48 slots into the groove 29.

At this point, the mask is already assembled but, as mentioned earlier, any accidental impact could cause the detachment of the collars 40 from the frame 20. However, by lowering the locking plate 52 from the release end position to the locking end position of its stroke, the lower lateral sides 58 of the locking plate 52 fit into the notches 59 (formed in the thickness of the collars 40) passing through the slits 53 in the rings 22. The structure of the mask is thus stabilized in its assembled position.

To disassemble the mask, e.g. to replace a lens, first the locking plate 52 is raised by pulling the flange 54. Then the upper flange 41 is forced so as to disengage the tooth 44 from the back of the ring 22 and the rib 48 from the groove 29, then the above-described assembly steps are repeated in reverse order until the lens requiring replacement can be removed.

Various modifications and alterations to the present invention may be appreciated based on a review of this disclosure. These changes and additions are intended to be within the scope and spirit of the invention as defined in by the following claims.

What is claimed is:

1. A scuba diving mask with corrective lenses comprising a frame with a pair of rings connected by a bridge, each of the rings having an internal flange on which the lip of a flexible skirt, a corresponding lens and a lens-retaining collar rest, the collar being attached with a snap action to the corresponding ring, wherein a seat is formed in the bridge substantially in the lying plane of the lenses and extending laterally to the upper internal portion of the two rings, the seat containing a locking plate slidable between two opposite end stroke positions, a locking end position and a release end position respectively, when the locking plate is in the locking position the lateral sides of the locking plate extend inside the rings and are engaged in corresponding notches provided in the upper internal rim of the lens-retaining collars.

2. The scuba diving mask set forth in claim 1, wherein the seat includes a slot formed inside the bridge.

3. The scuba diving mask set forth in claim 1, wherein the locking plate is provided with an upper flange that limits its downward displacement and that enables it to be grasped and lifted.

4. The scuba diving mask set forth in claim 1, wherein the locking plate has at least one projection suitable for slidingly engaging in a corresponding opening provided on the inner surface of the seat in the bridge, the length of the opening defining the end stroke positions of the locking plate.

5. The scuba diving mask set forth in claim 1, wherein the projection is formed by a pair of feet projecting from respective legs of the locking plate and slidingly engaging in the locking plate and slidingly engaging in the openings formed correspondingly in a wall of the seat.

6. The scuba diving mask set forth in claim 1, wherein each lens-retaining collar has one or more ribs on the outer lateral surface suitable for engaging in corresponding grooves formed on the inner surface of the rings of the frame.

7. The scuba diving mask set forth in claim 1, wherein each lens-retaining collar has at least one flange that surrounds the outer contour of the corresponding ring.

8. The scuba diving mask set forth in claim 6, wherein the at least one flange is inserted in a corresponding housing formed in the front surface of the rings.

9. The scuba diving mask set forth in claim 6, wherein the lens-retaining collar has several flanges, one of which has a rim ending with a tooth that engages in a corresponding groove provided on the rear of the ring.
